(19) United States
(12) Patent Application Publication
(10) Pub. No.: US 2023/0165236 A1
(43) Pub. Date: Jun. 1, 2023

(54) SYSTEMS, METHODS, AND APPARATUS FOR LIQUID FERTILIZER DRAWBACK

(71) Applicant: Kinze Manufacturing, Inc., Williamsburg, IA (US)

(72) Inventors: Steve Nolte, Williamsburg, IA (US); Philip Willis, Williamsburg, IA (US); Denny Williams, Williamsburg, IA (US); Austin Flugum, Williamsburg, IA (US)

(21) Appl. No.: 18/052,672

(22) Filed: Nov. 4, 2022

Related U.S. Application Data
(60) Provisional application No. 63/263,605, filed on Nov. 5, 2021.

(51) Int. Cl. A01M 7/00; B05B 9/06; B05B 12/08; A01C 23/00

(52) U.S. Cl. CPC A01M 7/0092; A01C 23/007; B05B 9/06; B05B 12/085

(57) ABSTRACT

A drawback system is used with a liquid fertilizer distribution system to be used with agricultural implements. The drawback system may include a two-way, reversible pump that allows liquid fertilizer material to be transported from a system source or toward a system source. The drawback system allows liquid fertilizer that is not applied to an agricultural field to be cleared from piping, conduits, and/or other components of a liquid fertilizer system and drawn back into a holding chamber. The drawback system may also comprise a positive displacement pump in communication with a plurality of valves wherein manipulation of the valves can control the direction of the flow of liquid fertilizer, either from or toward a system/fluid source.

### CROSS REFERENCE TO RELATED APPLICATIONS

This application claims priority under 35 U.S.C. § 119 to provisional patent application U.S. Serial No. 63/263,605, filed Nov. 5, 2021. The provisional patent application is herein incorporated by reference in its entirety, including without limitation, the specification, claims, and abstract, as well as any figures, tables, appendices, or drawings thereof.

### FIELD OF THE INVENTION

The invention relates generally to an apparatus, system, and/or corresponding method of use in at least the delivering and drawing back of liquid products, such as for a liquid application system, generally applicable to fertilizers. More particularly, but not exclusively, the invention relates to an apparatus, system, and/or method for a liquid fertilizer drawback system to be used with a liquid fertilizer distribution system.

### BACKGROUND OF THE INVENTION

Fertilizer systems generally consist of the application of either dry or liquid fertilizers. For dry fertilizer systems, they use a granular or other forms of fertilizer that are difficult to handle and apply, and difficult to blend and to apply uniformly. Because of this, other prior art has transitioned to liquid fertilizers.

A problem with liquid fertilizers is that the fertilizer material can be hazardous or caustic toward people, animals, the environment, and even the machinery used to distribute the fertilizer. Excess fertilizer that is left in the piping or conduits of fertilizer distribution systems for use in agriculture can often erode and degrade the distribution system’s machinery and equipment. Additionally, fertilizer material that has exited the holding chamber, such as a tank, of a distribution system but does not navigate entirely through the system to be applied to an agricultural field such that it is left in the piping or conduits of a distribution system is often wasted, or, due to the makeup of the liquid fertilizer, any remaining product can stick to and/or harden inside the conduits, which reduces the usable space of conduits and affects the operation of the system. In addition to eroding or degrading the equipment, the fertilizer material left in the piping and conduits of the distribution system may eventually leak out of the system, which potentially may have a harmful effect on the people, animals, and the environment to which it comes into contact. Additionally, fertilizer material being wasted or leaking out of the system is not cost effective, as the human operator may have to purchase additional fertilizer material to replace the wasted fertilizer material.

Thus, there exists a need in the art for an apparatus which provides a liquid fertilizer drawback system by which the system can draw any unused fertilizer material left in the piping, conduits, or other components of a fertilizer distribution system back into the holding chamber, such as a tank/hopper.

### SUMMARY OF THE INVENTION

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the invention to improve on or overcome the deficiencies in the art.

It is a further object, feature, and/or advantage of the invention to draw unused fertilizer material that has exited its holding chamber but has not been applied to an agricultural field back into the holding chamber. This allows for fertilizer material to not be left in the piping, conduits, or other components of a distribution system wherein the caustic fertilizer material may erode, degrade, block, or otherwise damage the apparatus involved. Thus, the drawback system improves the durability and longevity of the apparatus of the systems involved. Also, by drawing unused fertilizer back into a holding chamber, the drawback system does not waste unused fertilizer material, which improves efficiency and cost effectiveness. Further, by drawing unused fertilizer back into a holding chamber, any unused fertilizer material, which is potentially caustic or hazardous, will not inadvertently leak out of the system into the environment. Therefore, the drawback system also improves safety and environmental friendliness.

It is still yet a further object, feature, and/or advantage of the invention to improve upon the wasteful state of the art by providing a means to draw unused fertilizer material that has exited its holding chamber back into the holding chamber.

It is still yet a further object, feature, and/or advantage of the invention to use a two-way, reversible pump in order to provide a reversible flow so that fertilizer material can flow both from a system source and toward a system source.

It is still yet another object, feature, and/or advantage of the invention to use a positive displacement pump, such as a diaphragm pump, with one or more valves wherein the valves may be manipulated to provide a reversible flow so that fertilizer material can flow both from a system source and toward a system source.

The system disclosed herein can be used in a wide variety of applications. For example, the system can be used on an agricultural implement to provide reversible flow for a fertilizer distribution system and to draw fertilizer material back into a holding chamber. The system disclosed can also be used for the regulation, administering, distribution, and drawing back in of pesticides, herbicides, fungicides, and the like which are in liquid form.

It is preferred the apparatus be safe, cost effective, and durable. For example, some of the purposes/advantages of the system include improving efficiency, cost effectiveness, durability and longevity of equipment, and safety by mitigating wasteful use of fertilizer by drawing unused fertilizer back into a holding chamber. By drawing unused fertilizer back into a holding chamber, the system also provides the advantage of environmental friendliness as unused fertilizer material that could potentially leak out of certain components of the system is drawn back into a holding chamber.

Methods can be practiced which facilitate use, manufacture, assembly, maintenance, and repair of a system which accomplish some or all of the previously stated objectives.

The system can be incorporated into larger designs which accomplish some or all of the previously stated objectives.

According to some aspects of the present disclosure, a liquid fertilizer drawback system for use with an agricultural implement comprises a two-way, reversible pump to transport liquid fertilizer from a system source or toward a system source, wherein the pump is in communication with a motor to transport the liquid fertilizer.

According to at least some aspects of some embodiments of the present disclosure, the system further comprises a flow meter to display the flow of the liquid fertilizer.

According to some at least some aspects of some embodiments the present disclosure, the pump is a vane pump.

According to at least some aspects of some embodiments of the present disclosure, the system source is a tank.

According to at least some aspects of some embodiments of the present disclosure, the system further comprises one or more pressure sensors to measure the pressure of the liquid fertilizer.

According to at least some aspects of some embodiments of the present disclosure, the system further comprises an implement control system comprising zero or more IPRs, zero or more IPNs, zero or more IPPs, and zero or more displays, wherein the implement control system can sense, measure, monitor, and/or control aspects of the drawback system.

According to at least some aspects of some embodiments of the present disclosure, a method for liquid fertilizer drawback for use with an agricultural implement comprises drawing liquid fertilizer back toward a system source using a two-way, reversible pump in communication with a motor.

According to at least some aspects of some embodiments of the present disclosure, the method further comprises allowing a user to offer input to perform and/or control the step of drawing liquid fertilizer back toward a system source.

According to at least some aspects of some embodiments of the present disclosure, a liquid fertilizer drawback system for use with an agricultural implement comprises a positive displacement pump to transport liquid fertilizer from a system source or toward a system source, wherein the pump is in communication with a motor to transport the liquid fertilizer, and a plurality of valves in communication with the pump to facilitate the flow of the liquid fertilizer.

According to at least some aspects of some embodiments of the present disclosure, the system further comprises a flow meter to display the flow of the liquid fertilizer.

According to at least some aspects of some embodiments of the present disclosure, the pump is a diaphragm pump.

According to at least some aspects of some embodiments of the present disclosure, the system source is a tank.

According to at least some aspects of some embodiments of the present disclosure, the system further comprises one or more pressure sensors to measure the pressure of the liquid fertilizer.

According to at least some aspects of some embodiments of the present disclosure, the plurality of valves can be manipulated to reverse the flow of the liquid fertilizer either from a system source or toward a system source.

According to at least some aspects of some embodiments of the present disclosure, the system further comprises an implement control system comprising zero or more IPRs, zero or more IPNs, zero or more IPPs, and zero or more displays, wherein the implement control system can sense, measure, monitor, and/or control aspects of the drawback system.

According to at least some aspects of some embodiments of the present disclosure, a method for liquid fertilizer drawback for use with an agricultural implement comprises drawing liquid fertilizer back toward a system source using a positive displacement pump in communication with a motor and a plurality of valves.

According to at least some aspects of some embodiments of the present disclosure, the method further comprises allowing a user to offer input to perform and/or control the step of drawing liquid fertilizer back toward a system source.

According to at least some aspects of some embodiments, the step of drawing liquid fertilizer comprises redirecting liquid fertilizer via one or more valves.

According to at least some aspects of some embodiments, the system comprises a first path for delivering the liquid fertilizer towards an end use, and a second path for drawing the liquid fertilizer back towards the system source.

According to at least some aspects of some embodiments, the methods further comprise purging the system after drawing the liquid fertilizer.

These and/or other objects, features, advantages, aspects, and/or embodiments will become apparent to those skilled in the art after reviewing the following brief and detailed descriptions of the drawings. Furthermore, the present disclosure encompasses aspects and/or embodiments not expressly disclosed but which can be understood from a reading of the present disclosure, including at least: (a) combinations of disclosed aspects and/or embodiments and/or (b) reasonable modifications not shown or described.

### BRIEF DESCRIPTION OF THE DRAWINGS

Several embodiments in which the invention can be practiced are illustrated and described in detail, wherein like reference characters represent like components throughout the several views. The drawings are presented for exemplary purposes and may not be to scale unless otherwise indicated.

FIG. 1 is a perspective view of an exemplary agricultural planting implement.

FIG. 2 is a front elevation view of the agricultural planting implement.

FIG. 3 is a side elevation view of the agricultural planting implement.

FIG. 4 is a perspective view of an exemplary agricultural vehicle.

FIG. 5 is a perspective view of an exemplary row unit to be used with an agricultural planting implement.

FIG. 6 is a side elevation view of the row unit.

FIG. 7A is a schematic drawing of components of a liquid fertilizer drawback system according to one embodiment in which the flow is from the system source.

FIG. 7B is a schematic drawing of components of a liquid fertilizer drawback system according to another embodiment in which the flow is toward the system source.

FIG. 8A is a block diagram of the embodiment depicted in FIG. 7A according to some aspects of the disclosure.

FIG. 8B is a block diagram of the embodiment depicted in FIG. 7B according to some aspects of the disclosure.

FIG. 9 is a block diagram of components of an embodiment of a liquid fertilizer drawback system according to some aspects of the disclosure.

An artisan of ordinary skill need not view, within isolated figure(s), the near infinite number of distinct permutations of features described in the following detailed description to facilitate an understanding of the invention.

### DETAILED DESCRIPTION OF THE INVENTION

The present disclosure is not to be limited to that described herein. Mechanical, electrical, chemical, procedural, and/or other changes can be made without departing from the spirit and scope of the invention. No features shown or described are essential to permit basic operation of the invention unless otherwise indicated.

Unless defined otherwise, all technical and scientific terms used above have the same meaning as commonly understood by one of ordinary skill in the art to which embodiments of the invention pertain.

The terms “a,” “an,” and “the” include both singular and plural referents.

The term “or” is synonymous with “and/or” and means any one member or combination of members of a particular list.

The terms “invention” or “present invention” are not intended to refer to any single embodiment of the particular invention but encompass all possible embodiments as described in the specification and the claims.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variable, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “scope” of the invention is defined by the appended claims, along with the full scope of equivalents to which such claims are entitled. The scope of the invention is further qualified as including any possible modification to any of the aspects and/or embodiments disclosed herein which would result in other embodiments, combinations, subcombinations, or the like that would be obvious to those skilled in the art.

The term “particulate material” shall be construed to have a broad meaning, and includes, but is not limited to, grain, seed, fertilizer, insecticide, dust, pollen, rock, gravel, dirt, stock, or some combination thereof. Particulate material can be mixed with air to form airborne matter.

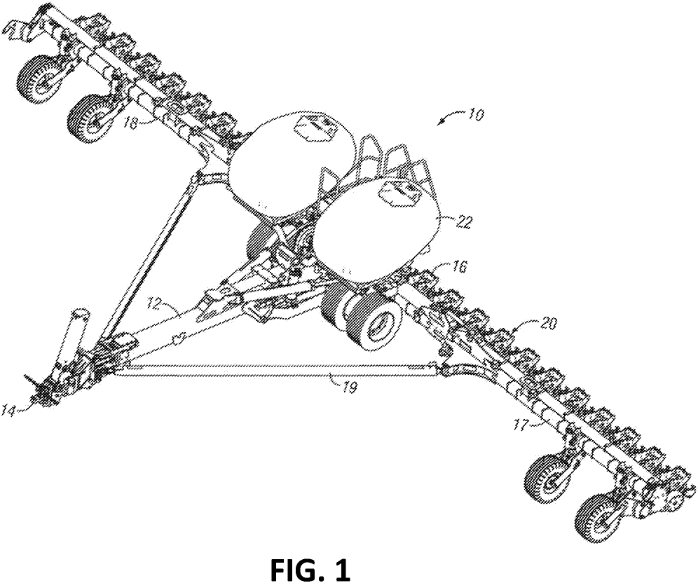

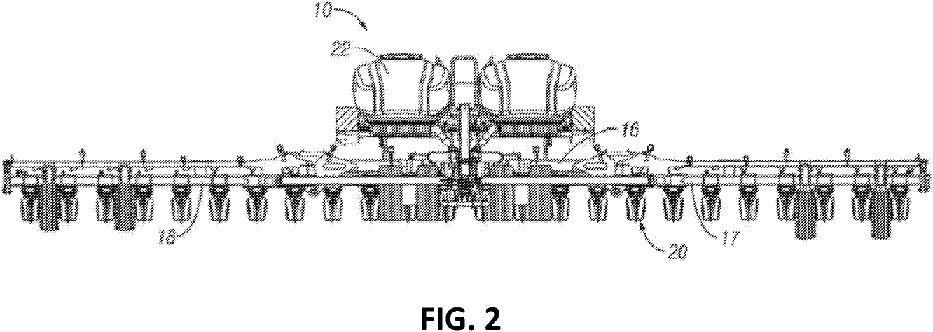

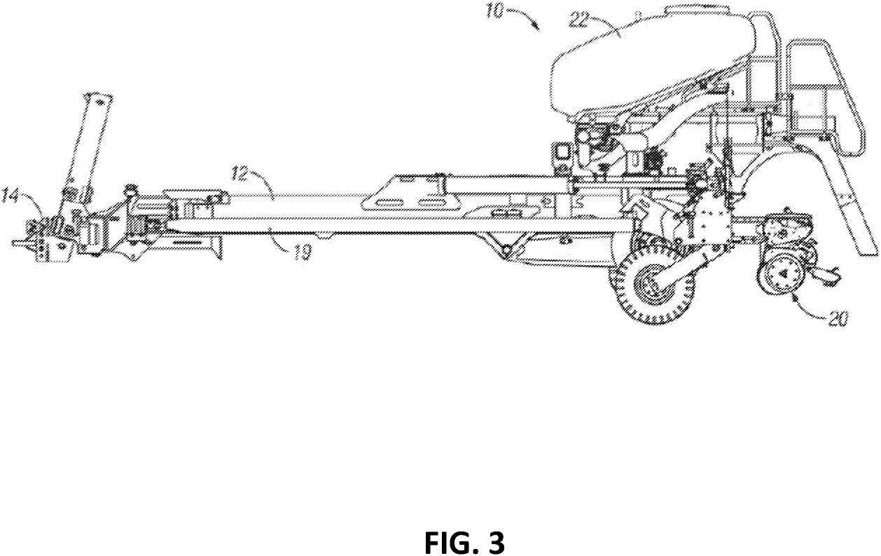

FIGS. 1-3 disclose an exemplary agricultural implement 10. The agricultural implement 10 as shown in the figures is a planting implement 10. Although the implement shown in FIGS. 1-3 is a planting implement, the drawback system, apparatus, and/or methods as shown and/or described herein may be used on agricultural implements other than planting implements, such as but not limited to, sprayers, fertilizer spreaders, tillage equipment, plows, discs, and the like. Additionally, the drawback system, apparatus, and/or methods may be used on a self-propelled agricultural vehicle (i.e., an unmanned or otherwise autonomous vehicle/implement). The implement 10 may be generally any implement for engaging with the ground or otherwise distributing a material, such as a particulate or liquid material to the ground. As will be understood, the implement includes ways to distribute material, such as a particulate material to various ground engaging apparatus to distribute said particulate material accurately, efficiently, with increased control, and in some embodiments, at high speed to distribute said particulate material to or in said ground. Furthermore, as will be understood, while the planting implement 10 as shown in the figures is provided, additional types of implements including additional planting implements with various features as is known can utilize the invention and/or aspects thereof to be able to distribute and apply the particulate material such as seed, or a liquid material such as liquid fertilizer, to the ground.

The planting implement 10 as shown in the figures includes a tongue 12 with a hitch 14 at a first end and a tool bar 16 extending generally transversely to the tongue 12 at a second end. The tool bar 16 extends to connect to a plurality of row units 20, which include ground engagement apparatus. The row units 20 may also include additional aspects such as metering elements, singulation elements, ground opening and/or closing elements, metering system, sensors, motors, and the like. However, it is to be appreciated that generally other types of row units, ground engaging elements, and/or metering elements can utilize any of the aspects of the invention disclosed herein. For example, the row units 20 could include fertilizer or other particulate and/or liquid material application apparatus, and the entrainment system disclosed be used to distribute the particulate and/or liquid material to the row units 20.

Extending outwardly from the toolbar 16 and also generally transverse to the tongue 12 are wing elements 17 and 18. The wing elements 17, 18 provide additional width of the toolbar such that additional row units 20 can be attached along thereto. The wings are essentially extensions of the central toolbar of the implement. This will allow for a greater number of row units 20 to be attached to the toolbar to be used for distributing a particulate material. Additional elements show in the figures include draft links 19, which generally connect the wings 17, 18 to the tongue 12. One or more actuators can be connected to the system to provide for the wings 17, 18 to be folded in a generally forward manner wherein they will be somewhat parallel to the tongue 12 to move the planting implement 10 from a field use configuration to a row use configuration. However, additional planting units may include that the toolbar is lifted and rotated, is folded rearwardly, is folded vertically, does not fold at all, or include some sort of combination thereof.

Agricultural planting implements, such as the exemplary one shown in FIGS. 1-3, are used to distribute, meter, and place particulate materials, such as seed, in operable and/or desired locations in a field. This is based, in part, on agronomical data, which is used to determine the optimal spacing, depth, and location of seed to give the seed the best chance to mature into a crop with the best possible yield. The exemplary agricultural implement 10 of FIGS. 1-3 includes central hoppers 22, wherein the central hoppers 22 may store particulate materials, such as seed, or liquid materials, such as liquid fertilizer, to be applied to an agricultural field. Thereby, the exemplary agricultural implement of FIGS. 1-3 may also apply liquid material, such as liquid fertilizer, to an agricultural field.

To further aid in increasing the performance and growing of crop from a planted seed, implements can include systems and other apparatus that are used to apply, place, or otherwise dispense a fertilizer, such as a liquid or dry fertilizer material. For agricultural planting implements, a fertilizer applicator/distribution system, such as the system disclosed in U.S. Pat. Application No. 63/261,973, filed Oct. 1, 2021, which is hereby incorporated in its entirety, can be included with the row units of the planter, or with the implement as a whole. This will provide the application of the fertilizer contemporaneously, or near-contemporaneously, with the planting of the seed. However, it should be appreciated that, if the implement is an applicator only, such as a sprayer, the system can continually provide needed liquid fertilizer on an as-needed basis. The system can include one or more hoppers/tanks, either at the bulk hopper site, at the individual row units, or split out to cover regions or sections of row units, wherein the application sites will be fed an amount of the liquid fertilizer.

A drawback system, such as shown and described herein, can be included as part of a liquid fertilizer application/distribution system such as the system disclosed in U.S. Pat. Application No. 63/261,973, to drawback unused liquid fertilizer into a holding chamber. The drawback system can be included with the row units of the planter at individual row units or split to cover regions or sections of row units.

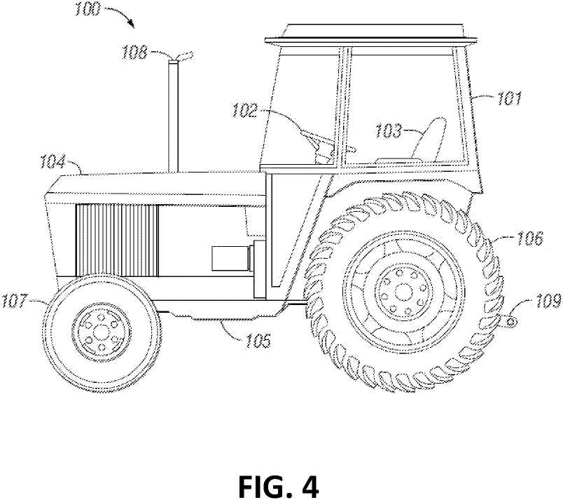

FIG. 4 discloses an exemplary agricultural vehicle 100 (e.g., a tractor) used for the purposes of towing machinery used in agriculture (e.g., agricultural implements). Accordingly, the vehicle may be referred to as a prime mover, tow vehicle, or the like. The agricultural vehicle 100 may include a cab 101 with a steering wheel 102 and a seat 103 for an operator. The agricultural vehicle 100 may also include a vehicle frame 104 which houses an engine located near the front axle of the agricultural vehicle 100 and in front of the cab 101. The cab 101 and vehicle frame 104 may be supported, structurally, by the agricultural vehicle’s chassis 105, which attaches to rear drivable wheels 106 and front steerable wheels 107, said front steerable wheels 107 operationally connected to the steering wheel 102. An exhaust pipe 108 allows carbon monoxide to exit the agricultural vehicle 100 during operation of the engine. A vehicle hitch 109 allows for connection between agricultural machinery, such as agricultural implements, and the agricultural vehicle 100.

In some aspects, the agricultural vehicle 100 shown in FIG. 4 could be used to tow the agricultural implement 10 shown in FIGS. 1-3. As mentioned, a liquid fertilizer distribution system and drawback system, as shown and described herein, wherein the drawback system is used as part of a liquid fertilizer distribution system to draw liquid fertilizer back into a holding chamber, could be included on the agricultural implement and/or agricultural vehicle.

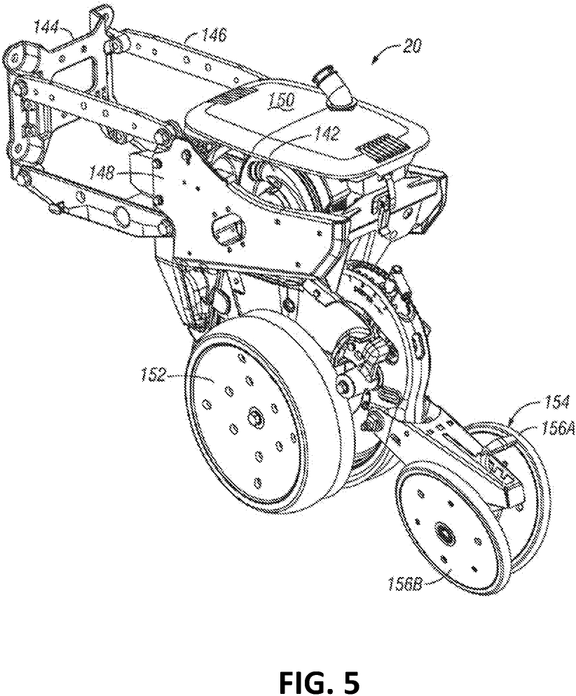

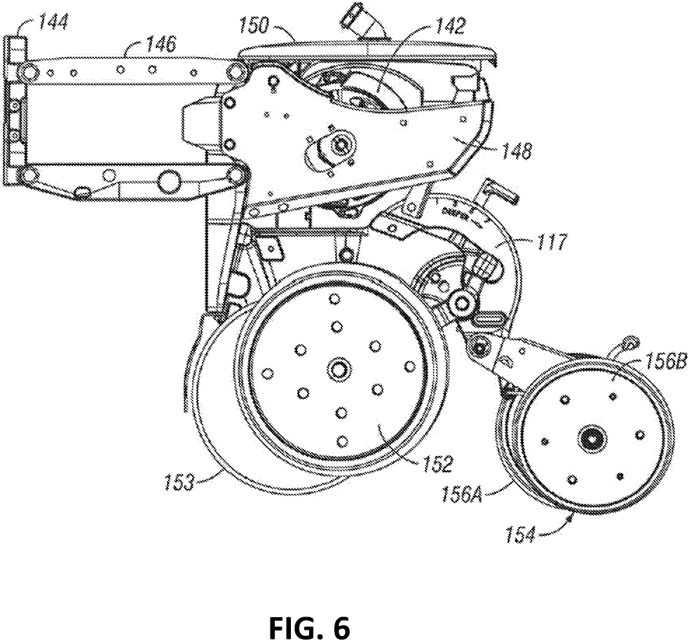

FIGS. 5 and 6 disclose an exemplary row unit of the plurality of row units 20, included as part of the implement 10, extending from the wings 17, 18 and the toolbar 16. A planter row unit 20 with an air seed meter 142 positioned therewith is shown in FIGS. 5 and 6. For example, the seed meter 142 may utilize a negative or positive air pressure to retain and transport seed about one or more seed discs within the seed meter housing. The row unit 20 and air seed meter 142 may be of the kind shown and described in U.S. Pat. No. 9,282,691, which is hereby incorporated in its entirety. However, it should be appreciated that aspects of embodiments of the present disclosure contemplate other types of seed meters, including mechanical, brush, finger, or the like, which may be used with the invention. In addition, the seed meter may be a multi-hybrid seed meter that is capable of dispensing one of a plurality of types, varieties, hybrids, etc. of seed at a row unit, such as by the use of multiple seed discs within the seed meter housing.

The row unit 20 includes a U-bolt mount (not shown) for mounting the row unit 20 to the planter frame or tool bar 16 (on central frame and wings 17, 18), as it is sometimes called, which may be a steel tube of 5 by 7 inches (although other sizes are used). However, other mounting structures could be used in place of the U-bolt. The mount includes a face plate 144, which is used to mount left and right parallel linkages 146. Each linkage may be a four bar linkage, as is shown in the figures. The double linkage is sometimes described as having upper parallel links and lower parallel links, and the rear ends of the parallel links are pivotally mounted to the frame 148 of the row unit 20. The frame 148 includes a support for the air seed meter 142 and seed hopper 150, as well as a structure including a shank 117 for mounting a pair of ground-engaging gauge wheels 152. The frame 148 is also mounted to a closing unit 154, which includes a pair of inclined closing wheels 156A, 156B. The row unit 20 also includes a pair of opener discs 153. While the row unit 20 shown in FIGS. 5 and 6 is configured to be used with a bulk fill seed system, it is to be appreciated that the row unit 20 may have one or more seed hoppers 150 at each of the row units 20. Exemplary versions of row units with individual hoppers are shown and described in U.S. Pat. No. 9,420,739, which is hereby incorporated in its entirety.

The implement 10 and row units 20 shown and described in FIGS. 5 and 6 include an air seed meter 142 for singulating and transporting seed or other particulate material from the seed delivery source to the created furrow in the field prior to the closing wheels 156A, 156B closing said furrow.

Still further, it should be appreciated that a fertilizer distribution system and a drawback system as disclosed herein could be used with other types of agricultural implements, including, but not limited to, sprayers, tillage equipment, plows, discs, and the like. The drawback system can be configured to work with generally any type of implement to be able to provide a reversible flow of liquid fertilizer to apply fertilizer material to an agricultural field as well as draw unused liquid fertilizer that is still in the piping, conduits, or other components of the system back into a holding chamber such as a tank/hopper.

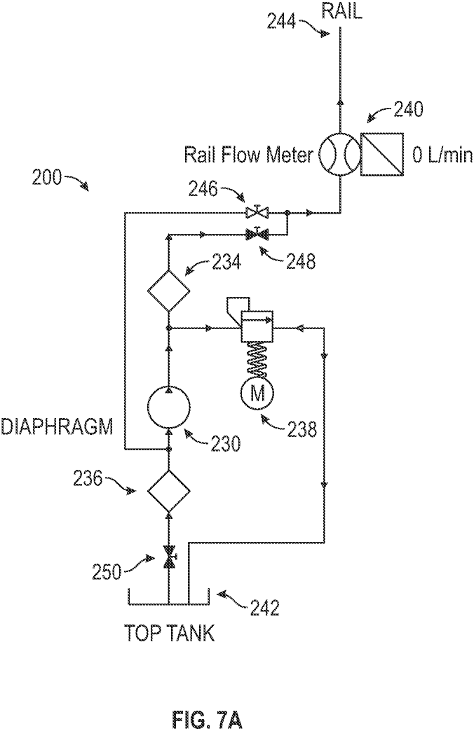

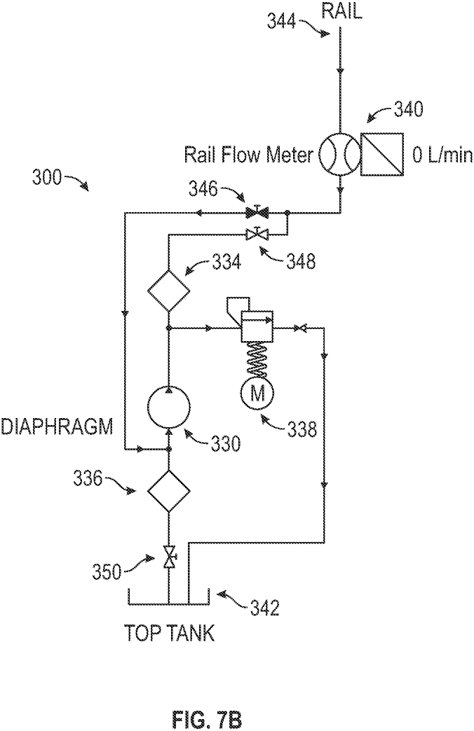

FIG. 7A shows an exemplary embodiment showing aspects of a drawback system 200 being used in connection with a liquid fertilizer distribution system according to the present disclosure. The drawback system 200 illustrated in FIG. 7A shows the drawback system in a state in which the fluid, such as liquid fertilizer, is being pulled from a fluid source to an agricultural implement to be applied to an agricultural field. In this embodiment, the fluid source may be any kind of holding chamber such as a tank or hopper 242. The fluid source may be any type of tank and/or hopper and the number of tanks/hoppers could number from one to N, where N can be any number greater than one. The tank(s) may be located at any part of the involved apparatus, including but not limited to an agricultural vehicle, an agricultural implement, and/or on individual row units of an agricultural implement. In FIG. 7A, the rail 244 represents the portion of the agricultural implement and/or individual row units wherein the fluid may be distributed to an agricultural field or otherwise eradicated from the fertilizer drawback system and/or fertilizer distribution system. This could be the row units, a toolbar, multiple toolbars, one or more conduits, or the like. The system 200 may include one or more conduits through which fluid, such as liquid fertilizer, may be transported throughout the system.

FIG. 7A also depicts a positive displacement pump 230. Positive displacement pumps can include, but are not limited to, diaphragm pumps, helical rotors (progressive cavity pumps), peristaltic hose pumps, piston pumps, rotary lobes (gear pumps), and vane pumps. While the exemplary embodiment in FIG. 7A includes a diaphragm pump, it should be appreciated that any type of positive displacement pump could be used. The diaphragm pump shown in FIG. 7A operates by way of a drive source, which is shown to be a hydraulic motor 238. However, other types of motors could be used to drive the positive displacement pump 230. FIG. 7A also includes a first valve 246, a second valve 248, and a third valve 250. In FIG. 7A, the first, second, and third valves are configured so that the positive displacement pump 230, in conjunction with the hydraulic motor 238, pump the liquid fertilizer from the tank 242 toward the rail 244. For example, in FIG. 7A, the first valve 246 is closed, and the second valve 248 is open, which directs the liquid fertilizer towards the rail. The third valve 250 is also opened to allow the liquid fertilizer from the tank to be directed, via the pump, towards the rail. Thus, the embodiment of the drawback system 200 that is depicted in FIG. 7A is directing the flow of the liquid fertilizer in the system 200 to be from a system source toward an agricultural implement to be applied to an agricultural field.

It should also be appreciated that the first valve 246 and second valve 248 could comprise a single, three-way valve instead of two, separate valves. In the case of the three-way valve, the pathway of the liquid fertilizer through the system could be determined by the three-way valve, such as by allowing one or another path to be opened/closed. This would still allow the liquid fertilizer to be distributed, such as in FIG. 7A, and retracted or drawn back, such as in FIG. 7B. Such a valve could take many forms, such as including, but not limited to, a three-way ball valve in a T- or L-shape. The T valve might be used to permit connection of one inlet to either or both outlets or connection of the two outlets. The L valve could be used to permit disconnection of both or connection of either but not both of two inlets to one outlet. The three-way valves could also be solenoid valves, which are electrically controlled, or any other type of operation for the valve.

FIG. 7A also includes a flow meter 240 as part of the system, wherein the flow meter 240 is in communication with the positive displacement pump 230 and the motor 238. When the liquid fertilizer is flowing from a system source toward an agricultural implement, the liquid fertilizer will pass through a flow meter 240 before it reaches the implement. When the liquid fertilizer is flowing toward a system source, depending on where the liquid fertilizer is in the system, the liquid fertilizer may pass through the flow meter 240. The flow meter 240 may be used to measure, monitor, and display the flow of the liquid fertilizer through the system, which can be used for confirmation that liquid fertilizer is moving through the system. According to at least some aspects of some embodiments, the flow meter 240 may measure the direction, speed, and/or flow rate of the flow of the liquid fertilizer. The flow meter 240 can then display the measured flow, allowing a human operator to view the measured direction, speed, and/or flow rate.

The exemplary embodiment of FIG. 7A also includes first and second pressure sensors/pressure strainers/suction strainers 234/236. The pressure sensors monitor the pressure of the liquid fertilizer system, which can provide information related to the operation thereof. For example, the sensors could detect an issue, such as if the sensed pressure is higher than it should be. This could be there is build-up, obstructions, or other issues moving the liquid fertilizer. The pressure sensors could also be used to determine the amounts of liquid fertilizer that is being moved through the system, such as by using in conjunction with a known density of the liquid fertilizer.

In addition, the strainers are used to aid in cleaning out particulates, particles, and/or other non-wanted items in the liquid fertilizer. This helps keep the system moving, and also mitigates blockage or other issues that could lead to higher pressure and/or damage to the fertilizer system. The strainers aid in keeping the system run smoothly in order to make sure that the desired liquid fertilizer is delivered and displaced from the system to the field. However, it should be appreciated that the strainers are option and not required in all instances of the liquid fertilizer system.

The first, second, and third valves of the system may be manipulated and/or configured so that the direction of flow of the liquid fertilizer is controlled, meaning that instead of flowing from a system source toward an agricultural implement to be applied to an agricultural field or otherwise eradicated from the system, the liquid fertilizer will flow from the rail and toward a system source to be stored in a holding chamber such as a tank/hopper. The valves may be manipulated via opening and/or closing the valves, or by other means. The valves may be generally any type of valve, including but not limited to, solenoid valves, ball valves (electric or mechanical), check valves, or the like. The manipulation of the valves can be in a number of ways, including via a user interface of the operator.

Still further, as disclosed herein, the first and second valves 246, 248 could be replaced with a three-way valve, which could control the flow of the liquid fertilizer from the system source and towards the implement, or returned towards the system source.

A user interface is how the user interacts with a machine. The user interface can be a digital interface, a command-line interface, a graphical user interface (“GUI”), oral interface, virtual reality interface, or any other way a user can interact with a machine (user-machine interface). For example, the user interface (“UI”) can include a combination of digital and analog input and/or output devices or any other type of UI input/output device required to achieve a desired level of control and monitoring for a device. Examples of input and/or output devices include computer mice, keyboards, touchscreens, knobs, dials, switches, buttons, speakers, microphones, LIDAR, RADAR, etc. Input(s) received from the UI can then be sent to a microcontroller to control operational aspects of a device.

The user interface module can include a display, which can act as an input and/or output device. More particularly, the display can be a liquid crystal display (“LCD”), a light-emitting diode (“LED”) display, an organic LED (“OLED”) display, an electroluminescent display (“ELD”), a surface-conduction electron emitter display (“SED”), a field-emission display (“FED”), a thin-film transistor (“TFT”) LCD, a bistable cholesteric reflective display (i.e., e-paper), etc. The user interface also can be configured with a microcontroller to display conditions or data associated with the main device in real-time or substantially real-time.

The interface could be connected to a control unit, such as a processing unit. A processing unit, also called a processor, is an electronic circuit which performs operations on some external data source, usually memory or some other data stream. Non-limiting examples of processors include a microprocessor, a microcontroller, an arithmetic logic unit (“ALU”), and most notably, a central processing unit (“CPU”). A CPU, also called a central processor or main processor, is the electronic circuitry within a computer that carries out the instructions of a computer program by performing the basic arithmetic, logic, controlling, and input/output (“I/O”) operations specified by the instructions. Processing units are common in tablets, telephones, handheld devices, laptops, user displays, smart devices (TV, speaker, watch, etc.), and other computing devices.

The connection could be wired or wireless. When wired, it could be via Ethernet or ISOBUS. Ethernet is a family of computer networking technologies commonly used in local area networks (“LAN”), metropolitan area networks (“MAN”) and wide area networks (“WAN”). Systems communicating over Ethernet divide a stream of data into shorter pieces called frames. Each frame contains source and destination addresses, and error-checking data so that damaged frames can be detected and discarded; most often, higher-layer protocols trigger retransmission of lost frames. As per the OSI model, Ethernet provides services up to and including the data link layer. Ethernet was first standardized under the Institute of Electrical and Electronics Engineers (“IEEE”) 802.3 working group / collection of IEEE standards produced by the working group defining the physical layer and data link layer’s media access control (“MAC”) of wired Ethernet. Ethernet has since been refined to support higher bit rates, a greater number of nodes, and longer link distances, but retains much backward compatibility. Ethernet has industrial application and interworks well with Wi-Fi. The Internet Protocol (“IP”) is commonly carried over Ethernet and so it is considered one of the key technologies that make up the Internet.

ISO 11783, known as Tractors and machinery for agriculture and forestry—Serial control and communications data network (commonly referred to as “ISO Bus” or “ISOBUS”) is a communication protocol for the agriculture industry based on the SAE J1939 protocol (which includes CANbus). The standard comes in 14 parts: ISO 11783-1: General standard for mobile data communication; ISO 11783-2: Physical layer; ISO 11783-3: Data link layer; ISO 11783-4: Network layer; ISO 11783-5: Network management; ISO 11783-6: Virtual terminal; ISO 11783-7: Implement messages application layer; ISO 11783-8: Power train messages; ISO 11783-9: Tractor ECU; ISO 11783-10: Task controller and management information system data interchange; ISO 11783-11: Mobile data element dictionary; ISO 11783-12: Diagnostics services; ISO 11783-13: File server; ISO 11783-14: Sequence control.

The direction that fluid, such as liquid fertilizer, flows, either from or toward a system/fluid source, can be determined based on user input. A user can offer input so that the pump and valves direct the fluid in the system to either flow from or toward a system/fluid source. Alternatively, a user can offer input such that the drawback system can function so that any unused fluid, such as liquid fertilizer material, is automatically drawn back toward the system/fluid source and stored in some type of holding chamber without a user manually directing the system to do so. For example, when liquid fertilizer ceases to be applied to an agricultural field, the drawback system will automatically draw any liquid fertilizer still in the fertilizer distribution system, whether it be in the piping, conduits, or any other components, back toward a system/fluid source to be stored in a holding chamber.

FIG. 7B shows another embodiment of a drawback system 300 being used in connection with a liquid fertilizer distribution system. The embodiment illustrated in FIG. 7B shows the drawback system in a state in which the fluid, such as liquid fertilizer, is being pulled toward a system/fluid source and, thus, is being drawn back into a holding chamber, which is the tank 342 in the embodiment of FIG. 7B.

The embodiment of the drawback system 300 shown in FIG. 7B includes the same components as the embodiment shown in FIG. 7A. However, the positive displacement pump and the valves are configured so that the fluid is being pulled toward a system/fluid source and is being drawn back into a holding chamber. Thus, the embodiment of the system 300 depicted in FIG. 7B includes a positive displacement pump 330, a first pressure sensor/pressure strainer/suction strainer 334, a second pressure sensor/pressure strainer/suction strainer 336, a motor 338, a flow meter 340, a tank/hopper 342, a rail 344 which represents an agricultural implement or row unit thereof to eradicate or dispense liquid fertilizer from the system, a first valve 346, a second valve 348, and a third valve 350. This embodiment may include one or more conduits through which fluid, such as liquid fertilizer, may be transported throughout the system 300.

Similar to the discussion regarding FIG. 7A, the first and second valves 346, 348 could be replaced with a single, three-way valve to accomplish the same features and goals of the system, which is to control the flow from the system source towards the end use, and returned or drawn back from the system and towards the containment tank/source.

The components of the embodiment of the system 300 depicted in FIG. 7B have the same characteristics and attributes and perform the same function as the corresponding components of the system 200 depicted in FIG. 7A with the exception of the first, second, and third valves, which are manipulated/configured to direct flow of liquid fertilizer toward a system source in FIG. 7B rather than from a system source as in FIG. 7A. For example, the positive displacement pump 330 in the embodiment of FIG. 7B is a diaphragm pump, but any positive displacement pump could be used such as helical rotors (progressive cavity pumps), peristaltic hose pumps, piston pumps, rotary lobes (gear pumps), vane pumps, and the like. The pump 330 shown in FIG. 7B operates by way of a drive source, which is shown to be a motor 338. The motor 338 of FIG. 7B is a hydraulic motor, however, any type of motor capable of driving a positive displacement pump in the system 300 could be used.

The flow meter 340 of FIG. 7B is in communication with the positive displacement pump 330 and the motor 338. Since the liquid fertilizer is flowing toward a system source in FIG. 7B, depending on where the liquid fertilizer is in the system, the liquid fertilizer may pass through the flow meter 340. The flow meter 340 may be used to measure, monitor, and display the flow of the liquid fertilizer through the system. According to at least some aspects of some embodiments, the flow meter 340 may measure the direction, speed, and/or flow rate of the flow of the liquid fertilizer. The flow meter 340 can then display the measured flow, allowing a human operator to view the measured direction, speed, and/or flow rate. While the tank 342 depicted in FIG. 7B is a simple tank/hopper, any type of holding chamber capable of holding liquid fertilizer could be used. The tank 342 may act as a system/fluid source. Additionally, just as in the embodiment depicted in FIG. 7A, according to the embodiment depicted in FIG. 7B the number of tanks/hoppers could number from one to N, where N can be any number greater than one. The tank(s) may be located at any part of the involved apparatus, including but not limited to an agricultural vehicle, an agricultural implement, and/or on individual row units of an agricultural implement. The rail 344 of FIG. 7B represents the portion of the agricultural implement and/or individual row unit wherein the fluid may be distributed to an agricultural field or otherwise eradicated from the fertilizer distribution system.

Just as the valves 246, 248, and 250 of FIG. 7A can be manipulated/configured to direct the flow of the liquid fertilizer either from or toward a system source, the first, second, and third valves 346, 348, and 350 of FIG. 7B can also be manipulated/configured to direct the flow of liquid fertilizer either from or toward a system source. According to the embodiment depicted in FIG. 7B, the valves 346, 348, and 350 are configured to direct liquid fertilizer toward the system source to draw any unused liquid fertilizer in the system 300 back into the tank 342. Unused fertilizer may be any fertilizer material that has exited the holding chamber of the system but has not been eradicated from the system. Thus, unused fertilizer material is still in the system, whether it be in the piping, conduits, or any other component of the system. As mentioned, a user can offer input so that the pump 330 and valves 346, 348, and 350 direct the fluid in the system to either flow from or toward a system/fluid source. Alternatively, a user may offer input so that the drawback system can function such that any unused fluid, such as liquid fertilizer material, is automatically drawn back toward the system/fluid source and stored in some type of holding chamber without a user manually directing the system to do so. For example, when liquid fertilizer ceases to be applied to an agricultural field, the drawback system will automatically draw any liquid fertilizer still in the fertilizer distribution system, whether it be in the piping, conduits, or any other components, back toward a system/fluid source to be stored in a holding chamber.

It is noted that the configurations of both FIGS. 7A and 7B utilize the positive displacement of the pump 230, 330 to move the fluid, either towards an end use location (e.g., the rail) or towards a holding container (e.g., the tank). The use of the valves will provide separate paths for the liquid fertilizer to move based upon the positive output of the pump. Therefore, the operation of the pump will remain the same regardless of the direction of the movement of the liquid fertilizer through the system.

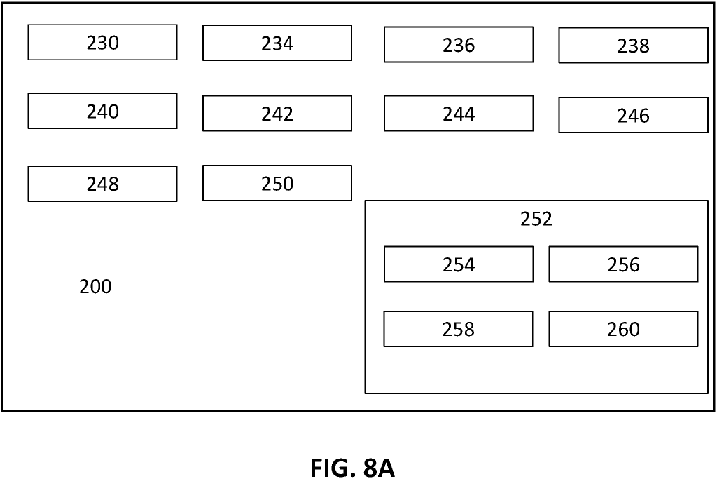

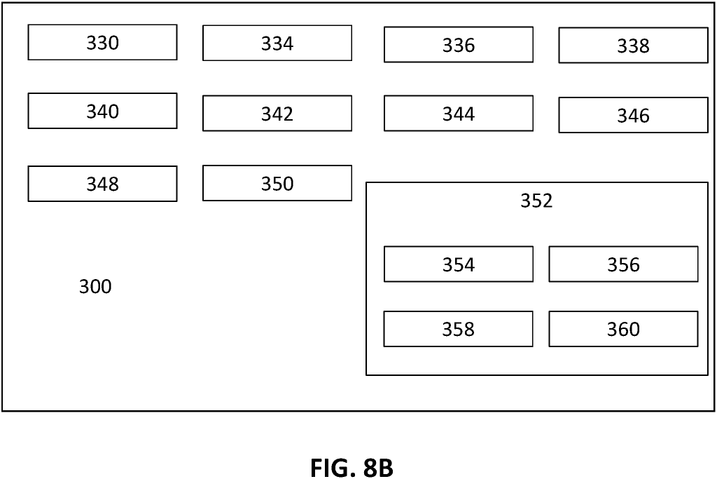

FIG. 8A shows a block diagram of the embodiment of the system 200 depicted in FIG. 7A according to some aspects of the disclosure. FIG. 8A shows that the system 200 includes a positive displacement pump 230, a first pressure sensor/pressure strainer/suction strainer 234, a second pressure sensor/pressure strainer/suction strainer 236, a motor 238, a flow meter 240, a tank 242, a rail 244, a first valve 246, a second valve 248, a third valve 250, an implement control system 252, an intelligent planter router/intelligent implement router (IPR/IIR) 254, an intelligent planter node/intelligent implement node (IPN/IIN) 256, an intelligent planter positioning/intelligent implement positioning (IPP/IIP) 258, and a display 260. The implement control system 252, IPR 254, IPN 256, IPP 258, and display 260 will be described herein.

FIG. 8B shows a block diagram of the embodiment of the system 300 depicted in FIG. 7B according to some aspects of the disclosure. FIG. 8B shows that the system 300 includes a positive displacement pump 330, a first pressure sensor/pressure strainer/suction strainer 334, a second pressure sensor/pressure strainer/suction strainer 336, a motor 338, a flow meter 340, a tank 342, a rail 344, a first valve 346, a second valve 348, a third valve 350, an implement control system 352, an intelligent planter router/intelligent implement router (IPR/IIR) 354, an intelligent planter node/intelligent implement node (IPN/IIN) 356, an intelligent planter positioning/intelligent implement positioning (IPP/IIP) 358, and a display 360. The implement control system 352, IPR 354, IPN 356, IPP 358, and display 360 will be described herein.

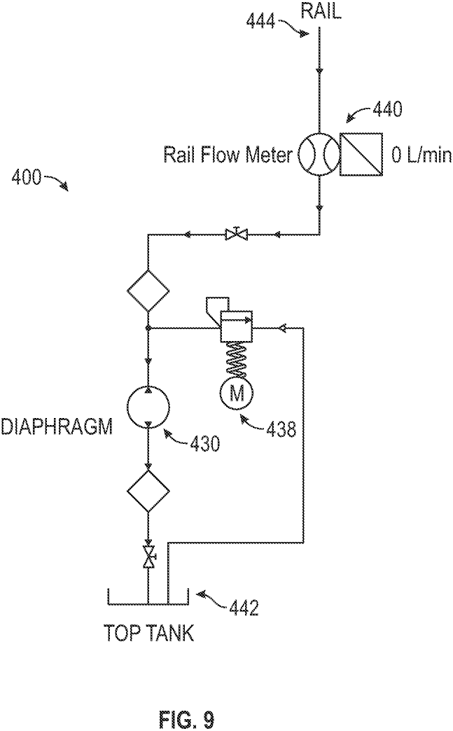

FIG. 9 shows another embodiment of a drawback system 400 being used in connection with a liquid fertilizer distribution system. The system 400 includes a two-way reversible pump 430, which can direct flow of liquid in two directions. The pump 430 can direct the flow of liquid fertilizer both from and toward a system source. When liquid fertilizer is pumped from a system source, it is generally eradicated from the system and applied to an agricultural field. When liquid fertilizer is pumped toward a system source, it is generally stored in a holding chamber such as a tank/hopper. The pump 430 of FIG. 9 is a vane pump, however, other two-way, reversible pumps could be used. The system 400 of FIG. 9 also includes a motor 438, which is used to drive the pump 430. The motor 438 in FIG. 9 is a hydraulic motor, however, other types of motors could be used to drive the two-way, reversible pump 430.

The two-way, reversible pump 430 allows the system 400 to direct flow of liquid fertilizer through the system both from a system/fluid source and to a system/fluid source. According to the embodiment in FIG. 9, the system/fluid source is a tank/hopper 442 that is used to hold liquid fertilizer. While a simple tank/hopper 442 is used to hold liquid fertilizer in FIG. 9, any type of holding chamber suitable to hold liquid fertilizer could be used. When liquid fertilizer is pumped from a system/fluid source, it is pumped toward a rail 444. The rail 444 represents the portion of the agricultural implement and/or individual row unit wherein the fluid may be distributed to an agricultural field or otherwise eradicated from the fertilizer distribution system. Additionally, the number of tanks/hoppers could number from one to N, where N can be any number greater than one. The tank(s) may be located at any part of the involved apparatus, including but not limited to an agricultural vehicle, an agricultural implement, and/or on individual row units of an agricultural implement. This embodiment may include one or more conduits through which fluid, such as liquid fertilizer, may be transported throughout the system 400.

The embodiment of the system 400 in FIG. 9 may also comprise a flow meter 440, wherein the flow meter 440 is in communication with the two-way, reversible pump 430 and the motor 438. Liquid fertilizer may flow through the flow meter 440 as it flows either from or toward a system source. The flow meter 440 may be used to measure, monitor, and display the flow of the liquid fertilizer through the system. According to at least some aspects of some embodiments, the flow meter 440 may measure the direction, speed, and/or flow rate of the flow of the liquid fertilizer. The flow meter 440 can then display the measured flow, allowing a human operator to view the measured direction, speed, and/or flow rate.

According to some aspects of the embodiment of FIG. 9, the direction that fluid, such as liquid fertilizer, flows, either from or toward a system/fluid source, can be determined based on user input. A user can offer input so that the pump and/or valves direct the fluid in the system to either flow from or toward a system/fluid source. Alternatively, a user can offer input such that the drawback system can function so that any unused fluid, such as liquid fertilizer material, is automatically drawn back toward the system/fluid source and stored in some type of holding chamber without a user manually directing the system to do so. For example, when liquid fertilizer ceases to be applied to an agricultural field, the drawback system will automatically draw any liquid fertilizer still in the fertilizer distribution system, whether it be in the piping, conduits, or any other components, back toward a system/fluid source to be stored in a holding chamber.

The embodiment of the system 400 depicted in FIG. 9 also includes an implement control system, an intelligent planter router/intelligent implement router (IPR/IIR), an intelligent planter node/intelligent implement node (IPN/IIN), an intelligent planter positioning/intelligent implement positioning (IPP/IIP), and a display. These components will be described herein.

All of the embodiments depicted in FIG. 7A-9 may include an implement control system that comprises an IPR, IPN, IPP, and a display. The implement control system, comprising an IPR, IPN, IPP, and display may be that which is disclosed in U.S. Pat. No. 10,952,365 which is hereby incorporated in its entirety. According to some aspects, the drawback system disclosed herein may utilize the implement control system, which may include zero or more IPRs, zero or more IPNs, zero or more IPPs, and zero or more displays. Pertinent to the disclosed drawback system, the implement control system of U.S. Pat. No. 10,952,365 may be adapted to detect, sense, monitor, and/or perform functionality related to fertilizer distribution and/or drawback of unused liquid fertilizer of a fertilizer drawback system into a holding chamber. For example, the features and capabilities of the drawback system may be performed and carried out by the implement control system and its components. As described herein, this includes the ability to accurately measure and monitor the flow of liquid fertilizer through the system, the ability to manipulate the valves of the system to reverse the flow such that liquid fertilizer either flows from or toward a system/fluid source, and the ability to manipulate a two-way pump to reverse flow such that liquid fertilizer either flows from or toward a system/fluid source. One or more IPPs may act as sensors to collect data related to these functions, and the one or more IPNs and IPRs may be used to control and perform certain functions. Further, control and performance of certain functions may depend on user input offered via the display of the implement control system. The display may be configured to display information and/or data to a user regarding the sensing, monitoring, measuring, and/or functionality of the system. The display may also be configured for a user to offer input.

For example, one or more IPPs can be used in conjunction with the flow meter when sensing and measuring the flow of the liquid. One or more IPPs can also work in conjunction with the valves of the system to sense and monitor whether the valves are open or closed. One or more IPPs can work in conjunction with the pump of the system to sense and monitor its functionality. Also, one or more IPPs can work in conjunction with the motor of the system to sense and monitor its functionality.

The display of the implement control system may be a digital interface, a command-line interface, a graphical user interface (“GUI”), oral interface, virtual reality interface, or any other way a user can interact with a machine (user-machine interface). For example, the display can include a combination of digital and analog input and/or output devices or any other type of UI input/output device required to achieve a desired level of control and monitoring for a device. Examples of input and/or output devices include computer mice, keyboards, touchscreens, knobs, dials, switches, buttons, speakers, microphones, LIDAR, RADAR, etc.

The display of the implement control system can act as an input and/or output device. More particularly, the display can be a liquid crystal display (“LCD”), a light-emitting diode (“LED”) display, an organic LED (“OLED”) display, an electroluminescent display (“ELD”), a surface-conduction electron emitter display (“SED”), a field-emission display (“FED”), a thin-film transistor (“TFT”) LCD, a bistable cholesteric reflective display (i.e., e-paper), etc.

Additionally, the drawback system disclosed herein may use Ethernet connections, Ethernet signals, Ethernet data transmission, and/or other types of connections, signals, and data transmission such as CAN bus or ISOBUS.

Ethernet is a family of computer networking technologies commonly used in local area networks (“LAN”), metropolitan area networks (“MAN”) and wide area networks (“WAN”). Systems communicating over Ethernet divide a stream of data into shorter pieces called frames. Each frame contains source and destination addresses, and error-checking data so that damaged frames can be detected and discarded; most often, higher-layer protocols trigger retransmission of lost frames. As per the OSI model, Ethernet provides services up to and including the data link layer. Ethernet was first standardized under the Institute of Electrical and Electronics Engineers (“IEEE”) 802.3 working group / collection of IEEE standards produced by the working group defining the physical layer and data link layer’s media access control (“MAC”) of wired Ethernet. Ethernet has since been refined to support higher bit rates, a greater number of nodes, and longer link distances, but retains much backward compatibility. Ethernet has industrial application and interworks well with Wi-Fi. The Internet Protocol (“IP”) is commonly carried over Ethernet and so it is considered one of the key technologies that make up the Internet.

ISO 11783, known as Tractors and machinery for agriculture and forestry—Serial control and communications data network (commonly referred to as “ISO Bus” or “ISOBUS”) is a communication protocol for the agriculture industry based on the SAE J1939 protocol (which includes CAN bus). The standard comes in 14 parts: ISO 11783-1: General standard for mobile data communication; ISO 11783-2: Physical layer; ISO 11783-3: Data link layer; ISO 11783-4: Network layer; ISO 11783-5: Network management; ISO 11783-6: Virtual terminal; ISO 11783-7: Implement messages application layer; ISO 11783-8: Power train messages; ISO 11783-9: Tractor ECU; ISO 11783-10: Task controller and management information system data interchange; ISO 11783-11: Mobile data element dictionary; ISO 11783-12: Diagnostics services; ISO 11783-13: File server; ISO 11783-14: Sequence control.

Additional aspects that may be included as part of any of the aspects of any of the embodiments disclosed in the present application include the ability to wash and/or purge the fertilizer system, such as after the system has been drawn back or otherwise relieved of the unused fertilizer in the lines. For example, water, air, or other fluids could be used to purge the system to further cleanse the system.

Therefore, as understood from the present disclosure, the drawback system provided includes the ability to control the direction of the flow of liquid fertilizer in a fertilizer distribution system such that the liquid fertilizer can flow from or toward a system/fluid source. Controlling the direction of the flow of liquid fertilizer through the system may be accomplished via manipulation of valves of the system and/or via a two-way, reversible pump. Thus, in addition to allowing liquid fertilizer to flow from a system/fluid source in order to be applied to an agricultural field, the drawback system allows unused liquid fertilizer to be drawn back toward a system/fluid source to be stored in a holding chamber such as a tank or hopper. By drawing unused fertilizer material back into a tank or hopper, the unused material is not left in the fertilizer distribution system and/or fertilizer drawback system, whether it be in conduits or piping or other components of the system. Fertilizer material can be caustic and may cause erosion or degradation of portions of a fertilizer distribution system and/or fertilizer drawback system.

Additionally, by being able to draw liquid fertilizer back into a tank/hopper, any unused fertilizer material is not wasted. This provides efficiency and cost effectiveness for the user since less fertilizer is wasted, resulting in less fertilizer needing to be purchased in order to apply fertilizer to an agricultural field. Further, drawing unused fertilizer back into a tank/hopper provides increased safety and is environmentally friendly. For example, unused fertilizer material that is left in a fertilizer distribution system and not drawn back into a tank/hopper, may potentially leak out of the system. By leaking out of a fertilizer distribution system, the chances a user comes into contact with potentially harmful fertilizer material is increased. Additionally, fertilizer material that leaks out of a fertilizer distribution system may potentially be hazardous or harmful to the environment.

From the foregoing, it can be seen that the invention accomplishes at least all of the stated objectives.

1. A liquid fertilizer drawback system for use with an agricultural implement comprising:
a two-way, reversible pump to transport liquid fertilizer from a system source or toward the system source, wherein the pump is in communication with a motor to transport the liquid fertilizer;
a conduit system between the two-way, reversible pump and an end use location for the liquid fertilizer;
wherein the two way, reversible pump is operable to both move liquid fertilizer in the conduit system towards and from the end use location and the system source.

2. The system of claim 1, further comprising a flow meter to display the flow of the liquid fertilizer.

3. The system of claim 1, wherein the pump is a vane pump.

4. The system of claim 1, wherein the system source is a tank.

5. The system of claim 1, further comprising one or more pressure sensors to measure the pressure of the liquid fertilizer.

6. The system of claim 1, further comprising an implement control system comprising zero or more IPRs, zero or more IPNs, zero or more IPPs, and zero or more displays, wherein the implement control system can sense, measure, monitor, and/or control aspects of the system of claim 1.

7. A method for liquid fertilizer drawback for use with an agricultural implement comprising:
moving liquid fertilizer from a system source towards an end use using a two-way, reversible pump via a conduit system;
drawing unused liquid fertilizer back toward the system source using the two-way, reversible pump in communication with a motor via the conduit system.

8. The method of claim 7, further comprising allowing a user to offer input to perform and/or control the step of drawing liquid fertilizer back toward a system source.

9. A liquid fertilizer drawback system for use with an agricultural implement comprising:
a positive displacement pump to transport liquid fertilizer from a system source or toward a system source, wherein the pump is in communication with a motor to transport the liquid fertilizer; and
a plurality of valves in communication with the pump to facilitate the flow of the liquid fertilizer;
wherein a conduit system includes a first path based upon the plurality of valves in which the liquid fertilizer moves towards an end use and a second path based upon the plurality of valves in which the liquid fertilizer moves towards the system source.

10. The system of claim 9, further comprising a flow meter to display the flow of the liquid fertilizer.

11. The system of claim 9, wherein the pump is a diaphragm pump.

12. The system of claim 9, wherein the system source is a tank.

13. The system of claim 9, further comprising one or more pressure sensors to measure the pressure of the liquid fertilizer.

14. The system of claim 9, wherein the plurality of valves can be manipulated to reverse the flow of the liquid fertilizer either from a system source or toward a system source.

15. The system of claim 9, further comprising an implement control system comprising zero or more IPRs, zero or more IPNs, zero or more IPPs, and zero or more displays, wherein the implement control system can sense, measure, monitor, and/or control aspects of the system of claim 6.

16. A method for liquid fertilizer drawback for use with an agricultural implement comprising:
drawing liquid fertilizer back toward a system source using a positive displacement pump in communication with a motor and a plurality of valves.

17. The method of claim 16, further comprising allowing a user to offer input to perform and/or control the step of drawing liquid fertilizer back toward a system source.

18. The method of claim 16, wherein the step of drawing liquid fertilizer comprises redirecting liquid fertilizer via one or more valves.

19. The method of claim 18, wherein the system comprises a first path for delivering the liquid fertilizer towards an end use, and a second path for drawing the liquid fertilizer back towards the system source.

20. The method of claim 16, further comprising purging the system after drawing the liquid fertilizer.
